(19) United States
(12) Patent Application Publication
(10) Pub. No.: US 2014/0229867 A1
(43) Pub. Date: Aug. 14, 2014

(54) USER INTERFACE (UI) CREATION SUPPORT SYSTEM, UI CREATION SUPPORT METHOD, AND PROGRAM

(71) Applicants: Shunsuke Suzuki, Tokyo (JP); Ryosuke Okubo, Tokyo (JP); Yukiko Tanikawa, Tokyo (JP)

(72) Inventors: Shunsuke Suzuki, Tokyo (JP); Ryosuke Okubo, Tokyo (JP); Yukiko Tanikawa, Tokyo (JP)

(21) Appl. No.: 14/111,879

(22) PCT Filed: Apr. 4, 2012
(86) PCT No.: PCT/JP2012/002346

§ 371 Date: Oct. 15, 2013

(30) Foreign Application Priority Data
Apr. 21, 2011 (JP) 2011-095177

(51) Int. Cl. G06F 3/048

(52) U.S. Cl. CPC G06F 3/048
USPC 715/762

(57) ABSTRACT

Considering a different perspective from an operability, in order to provide a technology which performs support of creating a User Interface (UI) screen suitable for each hypothetical user, a UI creation support system that performs support of creating the UI screen for respective users, a UI creation support system (1) is provided which includes an acquisition unit (10) which acquires an effect degree information indicating the degree of effect when processing through the UI screen is erroneously performed, and a UI configuration determination unit (20) which determines a configuration of the UI screen for the respective users based on the degree of the influence specified by the effect degree information.

### TECHNICAL FIELD

The present invention relates to a user interface (UI) creation support system, a UI creation support method, and a program.

### BACKGROUND ART

A user (hereinafter, a design user) creating a UI screen needs to understand a user (hereinafter, a hypothetical user) using the created UI screen and design a UI screen which is suitable for the hypothetical user. However, it is not easy to design a UI screen suitable for a hypothetical user.

In Patent Document 1, an information processing system is disclosed which improves a structure in which a device is likely to be erroneously operated. The information processing system is obtained from a plurality of operation target devices. The information processing system, along with extracting an operation pattern of each user from operation history information including at least information on the status of a device and a user's operation history, extracts an operation pattern (erroneous operation pattern) based on erroneous operation of the user from the operation pattern and specifies the cause of the erroneous operation from types of erroneous operation patterns. Then, the information processing system generates reflection information to reflect the information to a function of the operation target device based on the specified cause and changes a UI by applying the reflection information to the operation target device.

In Patent Document 2, an interaction system is disclosed which presents optimal operation guidance adapted to the operation proficiency of a user. The interaction device measures the time from an operable status to an input status by the user in order to determine a proficiency of the user based on the time. Then, the interaction device outputs operation guidance according to the proficiency specified by a result of the determination.

In Patent Document 3, a project prediction device is disclosed which quantitatively evaluates the effect caused by risk on schedule performance and cost efficiency of an earned value management to enable the prediction of a trading volume and completion of a project after a certain period of time from the present point in time during the project.

In Patent Document 4, a command display control system is disclosed which automatically removes a command display, which is not used much, from a screen; can additionally display the command display and the like on the screen; can integrate a series of operations including a selection of commands which are frequently made; and, in addition, can change a format between the command displays where an erroneous operation is likely to occur.

In Patent Document 5, a function evaluation method for evaluating a function of information processing device in different execution environments is disclosed.

### RELATED DOCUMENT

### Patent Document

[Patent Document 1] Japanese Unexamined Patent Publication No. 2010-34998
[Patent Document 2] Japanese Unexamined Patent Publication No. 8-44520
[Patent Document 3] Japanese Unexamined Patent Publication No. 2005-4461
[Patent Document 4] Japanese Unexamined Patent Publication No. 10-11255
[Patent Document 5] Japanese Unexamined Patent Publication No. 2008-9540

### DISCLOSURE OF THE INVENTION

In the related art, there exists a technology that designs a UI screen for each hypothetical user. However, in the related art, according to attributes (for example, proficiency) of each hypothetical user, the UI screen is designed so as to help each hypothetical user to easily operate the screen.

The present inventors have found out that a design of the UI screen that only focuses on operability is not the most appropriate as a UI screen for each hypothetical user in terms of the use of the UI screen, the screen-used scene, and the like.

Therefore, in the present invention, an object is to provide a technology that performs support for creating a UI screen suitable for each hypothetical user in consideration of perspectives other than operability.

According to the invention, a UI creation support system is provided which is a UI creation support system performing support for creating a UI screen for a user and includes an acquisition unit acquiring an effect degree information indicating the degree of effect for the respective users caused when a processing through the UI screen is erroneously performed, and a UI configuration determination unit determining a configuration of the UI screen for the user based on the degree of effect specified by the effect degree information.

In addition, according to the invention, there is provided a program which performs support for creating the UI screen for each user and causes a computer to function as an acquisition unit acquiring an effect degree information indicating the degree of effect for the respective users caused when processing through the UI screen is erroneously performed, or, based on the degree of effect specified by the effect degree information, the UI configuration determination unit determining a configuration of the UI screen for the respective users.

In addition, according to the invention, the UI creation support method that performs support for creating the UI screen for each user is provided, in which a computer is caused to execute an acquisition step which acquires an effect degree information indicating the degree of effect for the respective users caused when processing through the UI screen is erroneously performed and a UI configuration determination step which determines a configuration of the UI screen for the respective users based on the degree of effect specified by the effect degree information.

According to the present invention, a technology is provided for creating a UI screen suitable for each hypothetical user in consideration of perspectives other than operability.

### BRIEF DESCRIPTION OF THE DRAWINGS

Other objects in addition to the objects described above, the characteristics and advantages are illustrated to be further clear with the preferred embodiments described below and the accompanying drawings.

FIG. 1 is an example of a functional block diagram of a UI creation support system of an exemplary embodiment.

FIG. 2 is an example of information which a UI configuration holding unit of the embodiment holds.

FIG. 3 is a flowchart illustrating an example of the flow of processing of a UI creation support method of the embodiment.

### DESCRIPTION OF EMBODIMENTS

Hereinafter, an embodiment of the present invention will be described with reference to the drawings.

Each part of a present embodiment is realized by arbitrarily combining hardware and software around a CPU, a memory, a program loaded on the memory (in addition to a program stored in the memory in advance before time of shipping out a device, a program downloaded from a storage media such as a CD and the like or a server on the internet is also included), a storage unit such as a hard disk and the like which store the program, and a network connection interface of an arbitrary computer. Then, there are various modification examples in the realization method and the device, which are understood by those skilled in the art.

In addition, a functional block diagram used in a description of the embodiment does not illustrate a configuration of a hardware unit, but illustrates a functional unit block. In these diagrams, each device of the embodiment is described so as to be realized by a single device, but the realization means is not limited thereto. That is, it may be a configuration which is physically separated or a configuration which is logically separated.

First, the outline of the embodiment will be described.

In a UI creation support system of the embodiment, a design user performs support for creating a UI screen suitable for each hypothetical user. Specifically, in the UI creation support system of the embodiment, information indicating the degree of influence (for example, cost of damage) when processing through the UI screen (for example, information input) is erroneously performed is acquired by each hypothetical user. Then, based on the degree of influence, a configuration of the UI screen is determined by each hypothetical user. In the embodiment, the UI screen for a hypothetical user where the degree of influence is large has a configuration aiming at suppressing occurrences of mishandling, and the UI screen for a hypothetical user where the degree of influence is small has a configuration aiming at good operability.

Next, a configuration of the embodiment will be described in detail.

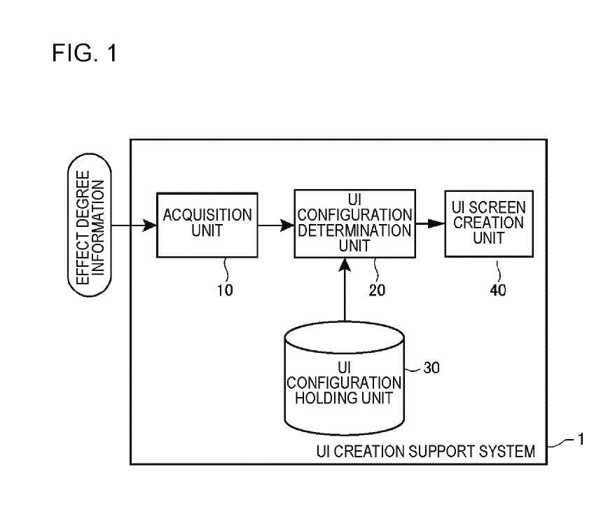

FIG. 1 illustrates a functional block diagram illustrating an example of a configuration of the UI creation support system 1 of the invention. The UI creation support system 1 of the embodiment includes an acquisition unit 10 and a UI configuration determination unit 20. The UI creation support system 1 of the embodiment may include a UI configuration holding unit 30 and/or a UI screen creation unit 40. Hereinafter, each unit will be described.

The acquisition unit 10 acquires an effect degree information indicating the degree of effect (hereinafter, referred to as the degree of mishandling effect) for each hypothetical user when processing through the UI screen is erroneously performed (for example, erroneous input). The UI screen herein is a UI screen that a design user is designing. The degree of mishandling effect includes, for example, the degree of effect on finances (hereinafter, the degree of monetary effect), the degree of effect on time (hereinafter, the degree of time effect), the degree of effect on humans (hereinafter, the degree of human effect), and the like.

In a step of designing the UI screen, various items of information related to the UI screen layout is provided to be clear, such as the use of the UI screen or the screen-used scene (for example, a day-to-day job, important projects, and an accounting job), contents of processing through the UI screen, types of input received from the UI screen (for example, information related to the day-to-day job, confidential information, input determining an order of less than a predetermined cost, and input determining an order of equal to or more than a predetermined cost), one or more hypothetical users operating the UI screen, types of inputs which each of the hypothetical users makes (for example, A and B—input determining an order less than a predetermined cost, C—input determining an order equal to or more than a predetermined cost), each attribute (for example, job title, department) of the hypothetical user, and the like.

For example, the design user, using the above-mentioned information, for each hypothetical user, may forecast a degree of mishandling effect to input a forecast value (the effect degree information) to the UI creation support system 1. In addition, as another example thereof, a design user may acquire a forecast result from other users (for example, a hypothetical user, customer) who forecast the degree of mishandling effect by using the above-mentioned information to input the acquired forecast value (the effect degree information) to the UI creation support system 1 as is. In addition, as another example thereof, the design user may input the effect degree information specified by a customer to the UI creation support system 1 as it is. Then, the acquisition unit 10 acquires information (the effect degree information) indicating the degree of mishandling effect which is input in this manner.

Here, the effect degree information will be described in detail. The effect degree information may be information including at least one of the degree of monetary effect, the degree of time effect, and the degree of human effect.

The degree of monetary effect may be determined based on, for example, a forecast cost of damage which is considered to occur due to erroneous processing through the UI screen. Specifically, a forecast cost needed to solve a problem considered to occur by the erroneous processing through the UI screen, a forecast cost considered to be obtained if there is no such problem, and the like are considered. This means that the larger the cost is, the greater the degree of effect is.

The degree of time effect may be determined by, for example, a forecast time needed to solve a problem considered to occur by the erroneous processing through the UI screen and/or time which can be spent in solving the problem considered to occur by the erroneous processing through the UI screen. The time which can be spent in solving the problem is, for example, an upper limit of down time and the like. The forecast time needed to solve the problem considered to occur by the erroneous processing through the UI screen is significant in that the degree of effect gets greater as the forecast time gets longer. On the other hand, the time which can be spent in solving the problem considered to occur by the erroneous processing through the UI screen denotes that the degree of effect gets greater as the time gets shorter.

The degree of human effect may be determined by at least one of, for example, a forecast number of people needed to solve a problem considered to occur by the erroneous processing through the UI screen, an organization which the problem considered to occur by the erroneous processing through the UI screen influences, and whether or not the problem considered to occur by the erroneous processing through the UI screen influences human life. The forecast number of people needed to solve the problem considered to occur by the erroneous processing through the UI screen denotes that the degree of effect gets greater as the forecast number of people gets larger. The organization which the problem considered to occur by the erroneous processing through the UI screen influences, for example, a case in which the problem influences a large scale such as all of society, outside the company, customers, and the like, has a large degree of effect. However, in a case in which the problem influences a limited scale such as only a hypothetical user himself or herself, only inside the company, only a department, and the like, it is possible to consider the degree of effect to be small. Whether or not the problem considered to occur by the erroneous processing through the UI screen influences human life denotes that the degree of effect is great in a case where the problem influences human life.

The above-mentioned example is merely an example, and the effect degree information may be determined based on other references.

The acquisition unit 10 receives an input of the effect degree information from the design user for each hypothetical user. When there is more than one processing through the UI screen, the design user may input the effect degree information indicating the degree of effect when the processing where the degree of effect is considered to be greatest is erroneously performed. A unit that receives an input of the effect degree information from the design user is not specially limited, and the acquisition unit 10 may receive an input of predetermined information such as a cost, time, the number of people, YES or NO, and the like through any input device such as a mouse, a keyboard, a touch panel display, a microphone, and the like. In addition, it is possible to use a drop-down list, an input box, and the like.

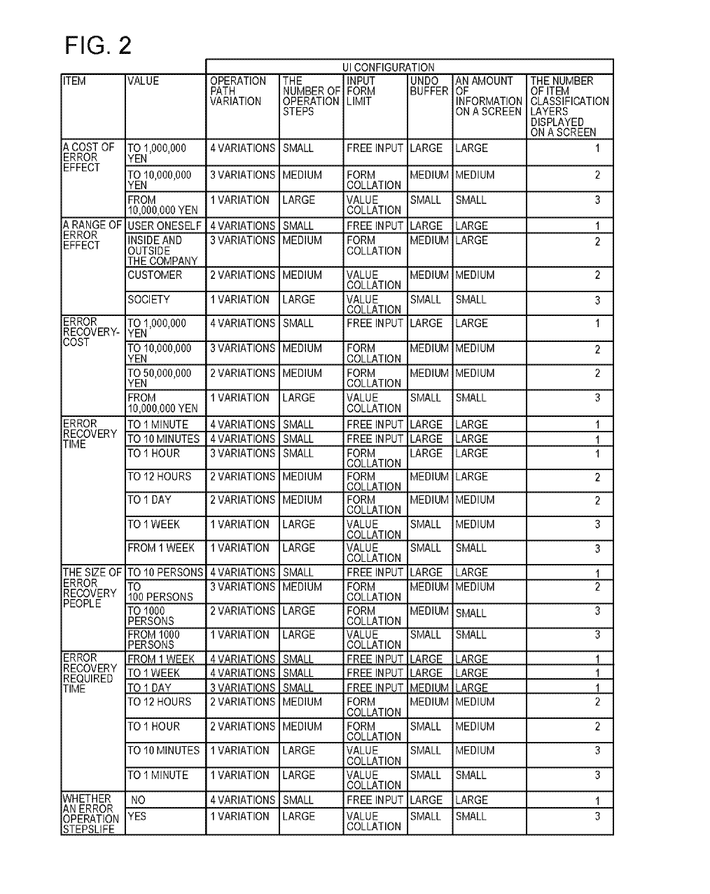

The UI configuration determination unit 20, based on the degree of effect specified by the effect degree information which the acquisition unit 10 acquired, determines a configuration of the UI screen for each hypothetical user. For example, the UI configuration determination unit 20, as illustrated in FIG. 2, may determine a configuration of the UI screen in reference to information (hereinafter, ‘response information on effect configuration’) determining a configuration content of the preferred UI screen according to the degree of effect. The UI configuration holding unit 30 illustrated in FIG. 1 holds the response information on effect as illustrated in FIG. 2 in advance.

In the response information on effect configuration illustrated in FIG. 2, in a column of ‘items’, various item contents indicating the degree of mishandling effect are described, and in a column of ‘values’, a value (condition) for classifying the degree of mishandling effect in each item into a plurality of levels is described. In a column of ‘UI configurations’, for each item indicating the degree of mishandling effect, a configuration content of the preferred UI screen is described according to each degree of mishandling effect. In the column of ‘UI configuration’, for each item indicating the degree of effect of mishandling, according to each degree of effect of mishandling, a configuration content of the preferred UI screen is described. The column of the UI configuration is divided into a plurality of columns, and a plurality of configuration items where a configuration of the UI screen is subdivided are described in each column.

Here, each item included in the response information influence configuration illustrated in FIG. 2 will be described in detail. First, items (the column of ‘items’) indicating the degree of effect of mishandling will be described.

A cost of error effect is determined based on the forecast cost of damage considered to occur by erroneous processing through the UI screen. Specifically, the forecast cost considered to occur by erroneous processing through the UI screen and the forecast cost considered to be obtained if there is no problem are included.

‘The range of error effect’ is determined based on the organization which the problem considered to occur by the erroneous processing through the UI screen influences. The number of organizations and the type thereof may be randomly determined. However, the range of error effect is classified into four types such as ‘user himself or herself’, ‘inside and outside company’, ‘customer’, and ‘society (total)’ in an example illustrated in FIG. 2. Then, in FIG. 2, in a case where a range which the problem influences is only user him or herself, the degree of mishandling effect is small, but while proceeding with ‘inside and outside company’, ‘customer’, and ‘society (total)’, the degree of mishandling effect is illustrated to be great.

An ‘error recovery cost’ is determined based on the forecast cost needed to solve the problem considered to occur by the erroneous processing through the UI screen.

An ‘error recovery time’ is determined based on time needed to solve the problem considered to occur by the erroneous processing through the UI screen.

A ‘number of error recovery people’ is determined based on the number of people needed to solve the problem considered to occur by the erroneous processing through the UI screen.

An ‘error recovery required time’ may be determined based on time which can be spent in solving the problem considered to occur by the erroneous processing through the UI screen. The time which can be spent in solving the problem may be an upper limit and the like of the down time determined by a Service Level Agreement (SLA), for example.

In ‘whether an error effects on human life’, the problem considered to occur by the erroneous processing through the UI screen is determined based on whether or not it influences human life.

An item indicating the degree of effect of mishandling illustrated in FIG. 2 is merely an example and may include other items or may not include one or more of the items which were illustrated. In addition, the value (condition) for classifying the degree of effect of mishandling in each item into a plurality of levels is merely an example, and it can be another value thereof and can be classified into other several levels.

Next, each configuration item (a column of ‘the UI configuration’) where a configuration of the UI screen is subdivided will be described.

‘Operation path variation’ determines the number of variations of an operation path according to each of the degrees of mishandling effects. The operation path includes, for example, ‘command input from the menu on the menu bar’, ‘command input from the context menu’, ‘command input from the toolbar’, ‘key shortcut’, and the like. When the number of variations of the operation path is small, operation content is limited, and a processing proceeds in the same order each time. Accordingly, it is considered that erroneous processing may be reduced through the UI screen. On the other hand, when the number of variations of the operation path is large, operability of the UI screen is considered to be better.

‘The number of operation steps’ is determined by mapping the size of the number of operation steps performed by the hypothetical user when executing a single processing with regards to each of the degrees of mishandling effect. For example, in a processing of performing an input of date ‘Jan. 1, 2011’ through the UI screen, a configuration in which a processing is completed by an input operation of ‘confirmation’ after inputting all of year (2011), month (Jan.), and date (1), and a configuration in which a message such as ‘Is it right?Yes or No’ or the like is output after inputting each of ‘year (2011), month (Jan.), date (1), an input operation of ‘Yes or No’ is performed at each time, and in which a processing is further completed by an input operation of ‘confirmation’ after inputting all of ‘year (2011)’, ‘month (Jan.)’, and ‘date (1)’ are different from each other in the number of operation steps. When the size of the number of the operation steps is large (the number is great), the operability gets worse. However since an opportunity of checking the processing content is increased, it is considered that erroneous processing through the UI screen may be reduced. On the other hand, when the size of the number of the operation steps is small (the number is small), the operability is considered to be better. To which extent ‘large’, ‘medium’, and ‘small’ illustrated in FIG. 2 is set is a design matter.

‘Input form limit’ determines a configuration (input form) set in an input box receiving an input of predetermined information (number, letter) according to each of the degrees of mishandling effect. The input form includes ‘value collation’, ‘form collation’, ‘free input’, and the like. The ‘value collation’ is a configuration of holding in advance a value which is allowable to be input to each input box and of allowing an input only when a value corresponding to any one of the values is input. ‘Form collation’ is a configuration of holding in advance a form of a value which is allowable to be input to each input box (for example, ‘XXX-YYYY (X and Y are figures), ‘the number of bits of input data’, and the like) and of allowing an input only when the value corresponding to the form is input. ‘Free input’ is a configuration allowing an input of all values without providing a limit. As a limit on an input form becomes stricter, the operability gets worse. However, it is believed that an erroneous processing through the UI screen may be reduced. On the other hand, as the limit on an input form is eased, it is considered that the operability gets better.

‘Undo buffer’ determines a size of a buffer (undo buffer) for undoing according to each of the degrees of mishandling effect. When the undo buffer is small, a range of past operations which may be traced back is narrow, so that operability gets worse. However, by moving the operation step forward and backward by undoing, it is possible to avoid an inconvenience such as losing a current operation step. Accordingly, it is believed that an erroneous processing through the UI screen can be reduced. On the other hand, when the undo buffer is large, a range of past operations which may be traced back is wide, so that it is believed that the operability is better. To what extent ‘large’, ‘medium’, and ‘small’ illustrated in FIG. 2 are set is a design matter. It is also possible to determine these items using the number of operations where undoing may be performed.

An amount of information on one screen determines an amount of information simultaneously displayed on one screen according to each of the degrees of mishandling effect. For example, even when displaying the same content of information on a screen, a plurality of UI screen configurations such as ‘a window configuration in which the entire information is simultaneously displayed’, ‘a configuration in which the information is classified into a plurality of windows and each window is selectively displayed’, ‘a window configuration in which information is selectively displayed on a screen while performing a scroll movement’ is considered, and an amount of information simultaneously displayed on each screen is different from each other. When an amount of information simultaneously displayed on one screen is small, a switching of a window and an operation such as a scroll movement and the like are required, so that it is believed that the operability gets worse. However, an appropriate amount of information may be displayed on a screen so that an oversight of the information on the screen may be suppressed, and an effect such as that the information on the screen may be easily understood is expected. As a result, it is believed that an erroneous processing through the UI screen can be reduced. On the other hand, when an amount of information simultaneously displayed on one screen is large, the switching of a window and an operation such as a scroll movement and the like are not required, so that it is believed the operability gets better. To what extent ‘large’, ‘medium’, and ‘small’ illustrated in FIG. 2 are set is a design matter.

‘The number of item classification layers displayed on a screen’ determines an amount of information simultaneously displayed on a single screen, such as ‘the amount of information on a screen’ as described above according to each of the degrees of mishandling effect. However, a type of information adjusting an amount of display is limited to information displayed according to each input box. In the UI screen, according to each input box, item information for recognizing input information (for example, ‘address’, ‘telephone number’, ‘name’, ‘product name’, and ‘the number of products’) is displayed. In addition, there is a case in which the item information is hierarchized to the predetermined number of layers by conceptualizing the item information to a broader concept. Information of broader concept is also displayed according to the input box. For example, input boxes corresponding to ‘address’, ‘telephone number’, and ‘name’ are made a group and displayed on a screen to display letters of ‘ordering person's information’ (broader concept) according to the information of the input boxes, and input boxes corresponding to ‘product name’ and ‘the number of products’ are made a group and displayed on a screen to display letters of ‘product order information’ (broader concept) according to the information of the input boxes. Furthermore, it is also possible to display letters of ‘ordering person information’ and ‘product order information’ which is a broader concept of ‘order information’. The hypothetical user may understand a type of information input to each input box based on the information.

In ‘the number of item classification layers’ displayed on a screen, according to each of the degrees of mishandling effect, the number of item information layers simultaneously displayed on one screen is determined. When the number of item information layers simultaneously displayed on one screen is large, the hypothetical user may easily understand a structure of steps of a plurality of input boxes. Accordingly, it is possible to group the plurality of input boxes and make a progress in input work in a stepwise manner, and by hierarchically grasping the plurality of input boxes, erroneous recognition of the information input to each input box may be reduced. Therefore, when the number of layers of item information simultaneously displayed on one screen is large, it is considered that an erroneous processing through the UI screen may be reduced. On the other hand, when the number of layers of item information simultaneously displayed on one screen is small, an amount of information simultaneously displayed on one screen may be reduced. Accordingly, the switching of windows and operations such as scroll movement are not required, and it is believed that the operability improves.

The configuration items illustrated in FIG. 2 are merely examples, and may include other configuration items and may include one or more of those illustrated. In addition, a content of each configuration item determined according to each of the degrees of mishandling effect is a design matter.

The UI configuration determination unit 20, when the acquisition unit 10 acquires the effect degree information of a hypothetical user, determines a configuration of the UI screen for a hypothetical user in reference to response information on effect configuration as illustrated in FIG. 2. For example, the acquisition unit 10 is assumed to acquire a range of error effect ‘customer’ as the effect degree information. In this case, the UI configuration determination unit 20 sets ‘a range of error effect’ and ‘customer’ as a key and searches for the response information on effect configuration illustrated in FIG. 2 to determine a configuration of ‘operation path variation: 2 variations’, ‘the number of operation steps: medium’, ‘input form limit: value collation’, ‘undo buffer: medium’, ‘an amount of information on a screen: medium’, and ‘the number of item classification layers displayed on a screen: two’.

When a plurality of items (column of items) displaying the degree of effect of mishandling is provided, order of priority may be assigned to the items. Then, when the acquisition unit 10 acquires the effect degree information related to a plurality of items, the UI configuration determination unit 20 may determine a configuration of the UI screen based on the degree of effect of item which has a high priority. A priority may be assigned to each configuration item which subdivides a configuration of the UI screen.

Referring back to FIG. 1, the UI screen creation unit 40, according to a determination of the UI configuration determination unit 20, creates the UI screen. A configuration of such a UI screen creation unit 40 may be realized according to the related art. For example, a module for realizing each of the configurations (for example: ‘which can be performed only using a mouse or a touch’) illustrated in FIG. 2 is stored in a storage device in advance, and the UI screen creation unit 40 may create one UI screen using the module.

In the embodiment, the UI screen for a hypothetical user which has a small degree of effect has a configuration pursuing a good operability. However, the UI screen is not limited thereto, and the configuration of the UI screen for a hypothetical user which has a small degree of effect may be a configuration focusing on other things. For example, as the degree of effect gets smaller, the number of function implementations may decrease, or design cost of the UI screen may be reduced. The examples illustrated herein are merely examples, and are not limited thereto.

The UI creation support system in the embodiment, for example, may be realized by installing a following program on a computer.

A program for performing support for creating the UI screen for each user is provided, and is a program which allows the computer to function as the acquisition unit acquiring the effect degree information indicating the degree of effect for the users caused when processing through the UI screen is erroneously performed and as the UI configuration determination unit determining a configuration of the UI screen for the respective users based on the degree of effect specified by the effect degree information.

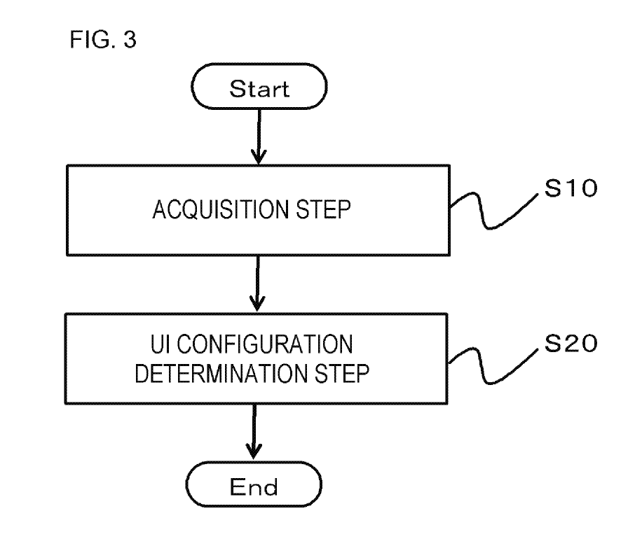

Next, using a flowchart illustrated in FIG. 3, an example of a UI creation support method of the embodiment will be described.

First, the acquisition unit 10 acquires an effect degree information indicating the degree of effect for the respective users caused when the processing through the UI screen is erroneously performed (S10: acquisition step). For example, the design user, as the effect degree information of a first hypothetical user, inputs a cost of error effect of only ‘5,000,000 Yen’ to the UI creation support system. Then, the acquisition unit 10 acquires the effect degree information.

Next, a UI configuration determination unit 20, based on a combination of effects specified by the effect degree information acquired by the acquisition unit 10 at step S10, determines a configuration of the UI screen for each user (S20: UI configuration determination step). For example, the UI configuration determination unit 20, referring to response information on effect configuration illustrated in FIG. 2 which is held by a UI configuration holding unit 30 and based on the cost of error effect ‘5,000,000 Yen’ acquired by the acquisition unit 10, determines a configuration of the UI screen for a first hypothetical user. In this case, the UI configuration determination unit 20 searches a column of items among the response information on effect configuration illustrated in FIG. 2 by setting ‘a cost of error effect’ as a key word and additionally searches a column of values by setting ‘5,000,000 Yen’ as a key word to specify a row satisfying both conditions. Then, a content of configuration items described on the row is determined as a configuration of the UI screen for a first hypothetical user. Here, configurations of ‘operation path variation: three variations’, ‘the number of operation steps: medium’, ‘input form limit: form collation’, ‘undo buffer: medium’, ‘an amount of information on a screen: medium’, and ‘ the number of item classification layers displayed on a screen: two’ is determined.

Here, an example of the acquisition unit 10 acquiring one piece of the effect degree information will be described. However, the acquisition unit 10, for example, may acquire a plurality of pieces of the effect degree information such as the cost of error effect of ‘5,000,000 Yen’ and a range of error effect ‘customer’. In this case, the UI configuration determination unit 20, for example, according to ‘order of priority of each item representing the degree of effect of mishandling’ determined in advance, may determine a configuration of the UI screen. For example, when an order of priority of the cost of error effect is higher than an order of priority of the range of error effect, the UI configuration determination unit 20 sets ‘a cost of error effect’ and ‘5,000,000 Yen’ as a key and searches for the response information on effect configuration illustrated in FIG. 2 in the same manner as described above to determine a configuration of ‘operation path variation: three variations’, ‘the number of operation steps: medium’, ‘input form limit: form collation’, ‘undo buffer: medium’, ‘an amount of information on a screen: medium’, and ‘the number of item classification layers displayed on a screen: two’.

An order of priority may be given for each of the plurality of configuration items which subdivides a configuration of the UI screen (in FIG. 2, item described in a column of UI). In this case, for example, in the configuration items illustrated in FIG. 2 (a column of ‘UI configuration’), an order of priority may be determined so that ‘operation path variation’ has a priority of the cost of error effect which is higher than the priority of the range of error effect and that ‘the number of operation steps’ has a priority of the range of error effect which is higher than the priority of the cost of error effect. In a case of the example, when the acquisition unit 10, for example, acquires two pieces of the effect degree information of the cost of error effect of ‘5,000,000 Yen’ and the range of error effect ‘customer’, the UI configuration determination unit 20, as a configuration of ‘operation path variation’, determines ‘three variations’ according to the cost of error effect of ‘5,000,000 Yen’ which has higher priority, and, as a configuration of ‘the number of operation steps’, determines ‘medium’ according to the range of error effect ‘customer’ which has a higher priority.

Next, an operation effect of the embodiment will be described.

According to the embodiment, considering the degree of mishandling effect of each hypothetical user, it is possible to determine a configuration of the UI screen suitable for each hypothetical user. In the embodiment, the UI screen for a hypothetical user which has a large degree of effect of mishandling is configured to focus on little occurrence of mishandling. Then, the UI screen for a hypothetical user which has a small degree of effect of mishandling is configured in other ways, which is not to focus on little occurrence of mishandling, but to focus on, for example, goodness of operability. When configured in the manner, there is a case in which the operability of the UI screen for a hypothetical user which has a large degree of mishandling effect gets worse. However, when the degree of mishandling effect is large, it is believed that a configuration in which the occurrence of mishandling is unlikely is focused on more than the operability is the UI screen suitable for the hypothetical user.

In addition, according to the embodiment, with only the input of the effect degree information related to the hypothetical user using the UI screen which is being designed to the UI creation support system of the embodiment by a design user, it is possible to determine the configuration of the UI screen which should be provided to the hypothetical user.

According to the embodiment, even a design user who has poor knowledge concerning UI screens can efficiently design an appropriate UI screen.

In addition, even to a design user who has good knowledge of the UI screen, determining a configuration content for each of the plurality of configuration items which subdivide a configuration of the UI screen is considered to be very troublesome and to be an operation requiring time and effort. According to the embodiment, for example, first, a first draft configured to have the UI screen which is being designed is created using the UI creation support system of the embodiment, and then it is possible to change the design of the UI screen based on the first draft. From this point of view, according to the embodiment, it is possible to reduce time and effort in the design of the UI screen.

This application claims priority based on Japanese Patent Application No. 2011-095177 filed on Apr. 21, 2011, whose disclosures are all incorporated herein.

1. A UI creation support system performing support for creating a user interface (UI) for respective users, the UI creation support system comprising:
an acquisition unit which acquires an effect degree information indicating the degree of the effect for the respective users caused when processing through the UI screen is erroneously performed and
a UI configuration determination unit which determines a configuration of the UI screen for the respective users based on the degree of effect specified by the effect degree information.

2. The UI creation support system according to claim 1,
wherein the effect degree information acquired by the acquisition unit includes at least one of a degree of monetary effect, a degree of time effect, and a degree of human effect.

3. The UI creation support system according to claim 2,
wherein the degree of monetary effect is determined based on a forecast cost of damage which is considered to occur by the error of the processing.

4. The UI creation support system according to claim 2,
wherein the degree of time influence is determined based on forecast time needed to solve a problem which is considered to occur by the error of the processing, and/or time which may be spent so as to solve a problem which is considered to occur by the error of the processing.

5. The UI creation support system according to claim 2,
wherein the degree of human effect is determined based on at least one of the forecast number of people needed to solve a problem which is considered to occur by an error of the processing, an organization which a problem which is considered to occur by the error of the processing influences, and whether or not a problem considered to occur by the erroneous processing influences human life.

6. The UI creation support system according to claim 1, further comprising:
a UI configuration holding unit which holds information for determining configuration contents of a UI screen according to the degree of effect,
wherein the UI configuration determination unit determines a configuration of the UI screen for the respective users referring to the UI configuration holding unit.

7. A non-transitory storage medium storing a program that performs support of creating a UI screen for the respective users, the program causing a computer to function as:
an acquisition unit acquiring an effect degree information indicating the degree of effect for the respective users caused when processing through the UI screen is erroneously performed; and
a UI configuration determination unit which, based on the degree of effect specified by the effect degree information, determines a configuration of the UI screen for the respective users.

8. A UI creation support method for performing support of creating the UI screen for the respective users, the method causing a computer to execute:
an acquisition step that acquires an effect degree information indicating the degree of effect for the respective users caused when processing through the UI screen is erroneously performed; and
a UI configuration determination step which, based on the degree of effect specified by the effect degree information, determines a configuration of the UI screen for the respective users.
